(19) United States
(12) Patent Application Publication
(10) Pub. No.: US 2024/0187833 A1
(43) Pub. Date: Jun. 6, 2024

(54) Home security via a Wi-Fi network

(71) Applicant: Plume Design, Inc., Palo Alto, CA (US)

(72) Inventors: Yoseph Malkin, San Jose, CA (US); Paul White, Burlingame, CA (US)

(21) Appl. No.: 18/073,139

(22) Filed: Dec. 1, 2022

(51) Int. Cl. H04W 4/90; H04W 4/029; H04W 8/00

(52) U.S. Cl. CPC H04W 4/90; H04W 4/029; H04W 8/005; H04W 84/12

(57) ABSTRACT

Systems and methods for home security include monitoring people and Wi-Fi client devices that connect and operate on a Wi-Fi network; and, responsive to an event, providing information related to people currently at a home associated with the Wi-Fi network. The method can include, prior to the monitoring, associating a person to one or more of the Wi-Fi client devices. The present disclosure leverages the ubiquitous deployment of Wi-Fi networks to provide various functions related to home security, elder care, safety, wellness, monitoring, and the like via a Wi-Fi network, and particularly by monitoring who is home, including even what room, location, etc. users are located.

### FIELD OF THE DISCLOSURE

The present disclosure generally relates to wireless networking systems and methods. More particularly, the present disclosure relates to systems and methods for home security, elder care, safety, wellness, monitoring, and the like via a Wi-Fi network.

### BACKGROUND OF THE DISCLOSURE

Wi-Fi networks (i.e., wireless local area networks (WLAN) based on the IEEE 802.11 standards) are ubiquitous, and the primary network used in homes. In fact, Wi-Fi is the most common technique for user device connectivity, and the applications that run over Wi-Fi are continually expanding. For example, Wi-Fi is used to carry all sorts of media, including video traffic, audio traffic, telephone calls, video conferencing, online gaming, and security camera video. Often traditional data services are also simultaneously in use, such as web browsing, file upload/download, disk drive backups, and any number of mobile device applications. That is, Wi-Fi has become the primary connection between user devices and the Internet in the home or other locations. The vast majority of connected devices use Wi-Fi for their primary network connectivity.

The vast deployment of Wi-Fi networks presents opportunities in home security, elder care, safety, wellness, monitoring, and the like. There are various safety emergencies or the like where it is critical to know who is in the home. Conventional techniques can include video monitoring which is extremely intrusive, wearable devices which may or may not be consistently used, and the like.

### BRIEF SUMMARY OF THE DISCLOSURE

The present disclosure relates to systems and methods for home security, elder care, safety, wellness, monitoring, and the like via a Wi-Fi network. The present disclosure leverages the ubiquitous deployment of Wi-Fi networks to provide various functions related to home security, elder care, safety, wellness, monitoring, and the like via a Wi-Fi network, and particularly by monitoring who is home, including even what room, location, etc. users are located. As described herein, the various features for home security, elder care, safety, wellness, monitoring, and the like can be summarized as “monitoring” or “monitoring features.”

In various embodiments, the present disclosure includes a method having steps, a cloud service configured to implement the steps, a processing device configured to implement the steps, and a non-transitory computer-readable medium with instructions that, when executed, cause one or more processors to implement the steps. The steps include monitoring people and Wi-Fi client devices that connect and operate on a Wi-Fi network; and, responsive to an event, providing information related to people currently at a home associated with the Wi-Fi network. The steps can further include, prior to the monitoring, associating a person to one or more of the Wi-Fi client devices. The steps can further include, responsive to a new Wi-Fi client device connecting to the Wi-Fi network, receiving an indication from a user assigning the new Wi-Fi client device to a person.

The information related to people can include detection of a specific Wi-Fi client device being on the Wi-Fi network where the specific Wi-Fi client device is previously assigned to a person. The providing information can be to one or more of emergency services, police, a security monitoring service, fire, and designated third persons. The providing information can be to a security monitoring service that uses the information to determine whether or not to dispatch any of police, fire, and medics. The information can be used in lieu of a camera to verify people are at a location of the Wi-Fi network. The providing information can include privacy controls where an administrator of the Wi-Fi network determines a level of the information from specific named persons to a count of the people.

The information can include at least a number of the people and an approximate location of any of the people in a location of the Wi-Fi network. The approximate location can be based on a radar sensing device associated with the Wi-Fi network. The approximate location can be based on disturbances in Wi-Fi signals of the Wi-Fi network. The approximate location can be based on which Wi-Fi client devices are connected to which access point in a multiple access point Wi-Fi network. The approximate location can be based on Ultrawide Bandwidth (UWB) detection. The steps can further include, responsive to Media Access Control (MAC) randomization of a Wi-Fi client device, correlating the randomized MAC address to a previously seen MAC address. The steps can further include identifying whether a person is at home where the Wi-Fi network is based on a type of Wi-Fi client device being on the Wi-Fi network. The type can be one of a wearable device, smart phone, tablet, automobile, and fitness tracker.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of various Wi-Fi network topologies for connectivity to the Internet.

FIG. 2A is a network diagram of the Wi-Fi network with cloud-based control.

FIG. 2B is a network diagram of an example implementation of the Wi-Fi network, as a distributed Wi-Fi network in a tree topology.

FIG. 3A is a block diagram of functional components of the access points, mesh nodes, repeaters, etc., in the Wi-Fi networks of FIG. 1.

FIG. 3B is a logical diagram of the access points, mesh nodes, repeaters, etc. with a middleware layer to enable operation with the cloud service.

FIG. 4 is a block diagram of functional components of a server, a Wi-Fi client device, or a user device that may be used with the Wi-Fi network of FIG. 1 and/or the cloud-based control of FIG. 2A.

FIG. 5 is a network diagram of a portion of a network associated with a network operator.

FIG. 6 is a diagram of a fixed wireless access system for wired and/or wireless connectivity.

FIGS. 7A-7K are screenshots of a mobile app illustrating the user detection feature.

FIG. 8 is a flow diagram illustrating an embodiment of a process for identifying a user device to counteract MAC randomization.

FIG. 9 is a flow diagram illustrating an embodiment of a process for utilizing information obtained from radar-based sensors to detect human movement within a domestic setting.

FIG. 10 is a flowchart of a home monitoring process.

### DETAILED DESCRIPTION OF THE DISCLOSURE

Again, the present disclosure relates to systems and methods for home security, elder care, safety, wellness, monitoring, and the like via a Wi-Fi network. The present disclosure leverages the ubiquitous deployment of Wi-Fi networks to provide various functions related to home security, elder care, safety, wellness, monitoring, and the like via a Wi-Fi network, and particularly by monitoring who is home, including even what room, location, etc. users are located. As described herein, the various features for home security, elder care, safety, wellness, monitoring, and the like can be summarized as “monitoring” or “monitoring features.”

In particular, the present disclosure leverages several functions performed in or with the Wi-Fi network and a cloud service. The functions include:
(1) Detection of who is or is not home, based on specific Wi-Fi client devices;
(2) Media Access Control (MAC) stitching which counteracts MAC randomization;
(3) Locating function in the Wi-Fi network, such as via radar antennas, Ultrawide Bandwidth (UWB) antennas, as well as via disturbances in Wi-Fi signals based on motion; and
(4) Fall detection such as via a smart ring.

### § 1.0 WI-FI NETWORK TOPOLOGIES

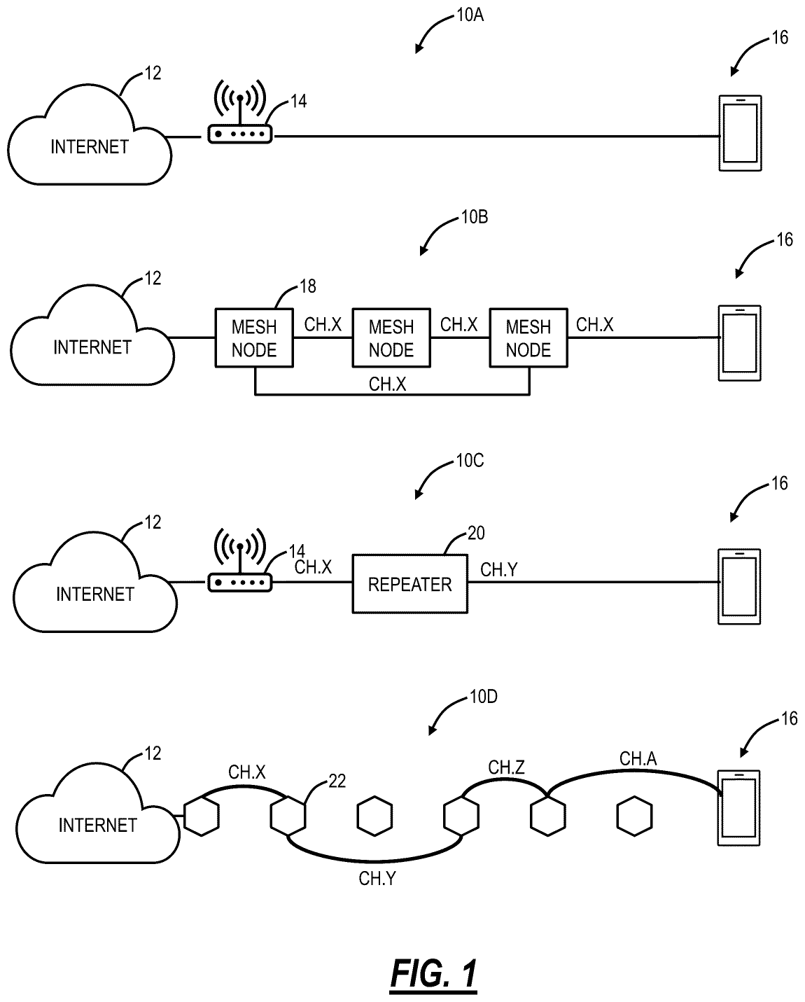

FIG. 1 is a network diagram of various Wi-Fi network 10 (namely Wi-Fi networks 10A-10D) topologies for connectivity to the Internet 12. The Wi-Fi network 10 can operate in accordance with the IEEE 802.11 protocols and variations thereof. The Wi-Fi network 10 is deployed to provide coverage in a physical location, e.g., home, business, store, library, school, park, etc. The differences in the topologies of the Wi-Fi networks 10 are that they provide different scope of physical coverage. As described herein and as known in the art, the Wi-Fi network 10 can be referred to as a network, a system, a Wi-Fi network, a Wi-Fi system, a cloud-based Wi-Fi system, etc. The access points 14 and equivalent (i.e., mesh nodes 18, repeater 20, and devices 22) can be referred to as nodes, access points, Wi-Fi nodes, Wi-Fi access points, etc. The objective of the nodes is to provide network connectivity to Wi-Fi client devices 16 which can be referred to as client devices, user equipment, user devices, clients, Wi-Fi clients, Wi-Fi devices, etc. Note, those skilled in the art will recognize the Wi-Fi client devices 16 can be mobile devices, tablets, computers, consumer electronics, home entertainment devices, televisions, Internet of Things (IoT) devices, or any network-enabled device.

The Wi-Fi network 10A includes a single access point 14, which can be a single, high-powered access point 14, which may be centrally located to serve all Wi-Fi client devices 16 in a location. Of course, a typical location can have several walls, floors, etc. between the single access point 14 and the Wi-Fi client devices 16. Plus, the single access point 14 operates on a single channel (or possible multiple channels with multiple radios), leading to potential interference from neighboring systems. The Wi-Fi network 10B is a Wi-Fi mesh network that solves some of the issues with the single access point 14 by having multiple mesh nodes 18, which distribute the Wi-Fi coverage. Specifically, the Wi-Fi network 10B operates based on the mesh nodes 18 being fully interconnected with one another, sharing a channel such as a channel X between each of the mesh nodes 18 and the Wi-Fi client device 16. That is, the Wi-Fi network 10B is a fully interconnected grid, sharing the same channel, and allowing multiple different paths between the mesh nodes 18 and the Wi-Fi client device 16. However, since the Wi-Fi network 10B uses the same backhaul channel, every hop between source points divides the network capacity by the number of hops taken to deliver the data. For example, if it takes three hops to stream a video to a Wi-Fi client device 16, the Wi-Fi network 10B is left with only ⅓ the capacity.

The Wi-Fi network 10C includes the access point 14 coupled wirelessly to a Wi-Fi repeater 20. The Wi-Fi network 10C with the repeaters 20 is a star topology where there is at most one Wi-Fi repeater 20 between the access point 14 and the Wi-Fi client device 16. From a channel perspective, the access point 14 can communicate to the Wi-Fi repeater 20 on a first channel, Ch. X, and the Wi-Fi repeater 20 can communicate to the Wi-Fi client device 16 on a second channel, Ch. Y. The Wi-Fi network 10C solves the problem with the Wi-Fi mesh network of requiring the same channel for all connections by using a different channel or band for the various hops (note, some hops may use the same channel/band, but it is not required), to prevent slowing down the Wi-Fi speed. One disadvantage of the repeater 20 is that it may have a different service set identifier (SSID), from the access point 14, i.e., effectively different Wi-Fi networks from the perspective of the Wi-Fi client devices 16.

The Wi-Fi network 10D includes various Wi-Fi devices 22 that can be interconnected to one another wirelessly (Wi-Fi wireless backhaul links) or wired, in a tree topology where there is one path between the Wi-Fi client device 16 and the gateway (the Wi-Fi device 22 connected to the Internet), but which allows for multiple wireless hops unlike the Wi-Fi repeater network and multiple channels unlike the Wi-Fi mesh network. For example, the Wi-Fi network 10D can use different channels/bands between Wi-Fi devices 22 and between the Wi-Fi client device 16 (e.g., Ch. X, Y, Z, A), and, also, the Wi-Fi system 10 does not necessarily use every Wi-Fi device 22, based on configuration and optimization. The Wi-Fi network 10D is not constrained to a star topology as in the Wi-Fi repeater network which at most allows two wireless hops between the Wi-Fi client device 16 and a gateway. Wi-Fi is a shared, simplex protocol meaning only one conversation between two devices can occur in the network at any given time, and if one device is talking the others need to be listening. By using different Wi-Fi channels, multiple simultaneous conversations can happen simultaneously in the Wi-Fi network 10D. By selecting different Wi-Fi channels between the Wi-Fi devices 22, interference and congestion can be avoided or minimized.

Of note, the systems and methods described herein contemplate operation through any of the Wi-Fi networks 10, including other topologies not explicated described herein. Also, if there are certain aspects of the systems and methods which require multiple nodes in the Wi-Fi network 10, this would exclude the Wi-Fi network 10A.

### § 1.1 Cloud-Based Control

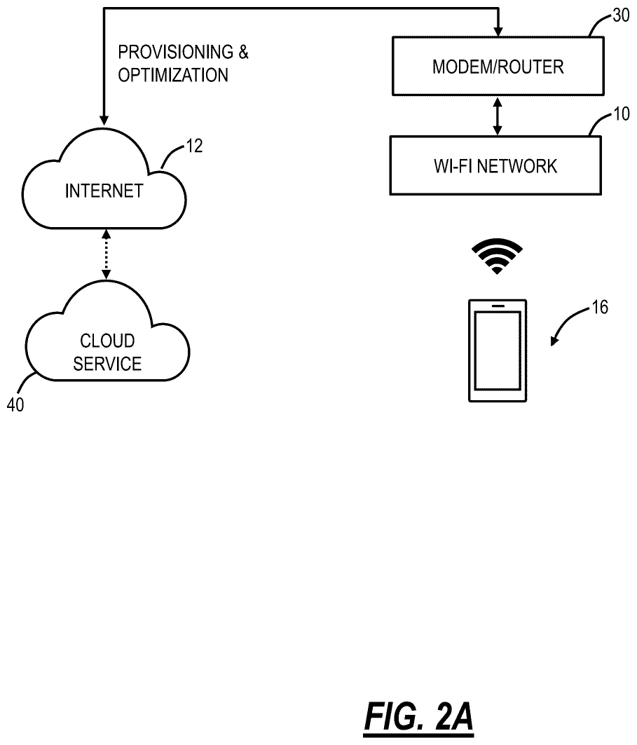

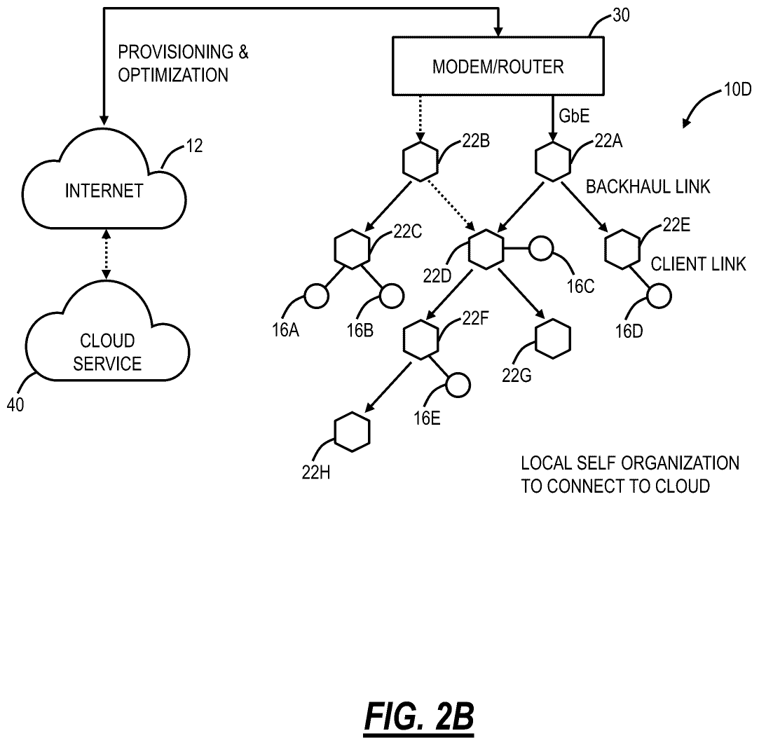

FIG. 2A is a network diagram of the Wi-Fi network 10 with cloud-based control. The Wi-Fi network 10 includes a gateway device which is any of the access points 14, the mesh node 18, or the Wi-Fi device 22 that connects to a modem/router 30 that is connected to the Internet 12. For external network connectivity, the modem/router 30 which can be a cable modem, Digital Subscriber Loop (DSL) modem, cellular interface, or any device providing external network connectivity to the physical location associated with the Wi-Fi network 10. In an embodiment, the Wi-Fi network 10 can include centralized control such as via a cloud service 40 located on the Internet 12 and configured to control multiple Wi-Fi networks 10. The cloud service 40 can receive measurement data, analyze the measurement data, and configure the nodes in the Wi-Fi network 10 based thereon. This cloud-based control is contrasted with a conventional operation that relies on a local configuration such as by logging in locally to an access point.

Of note, cloud-based control can be implemented with any of the Wi-Fi networks 10, with monitoring through the cloud service 40. For example, different vendors can make access points 14, mesh nodes 18, repeaters 20, Wi-Fi devices 22, etc. However, it is possible for unified control via the cloud using standardized techniques for communication with the cloud service 40. One such example includes OpenSync, sponsored by the Applicant of the present disclosure and described at www.opensync.io/documentation. OpenSync is cloud-agnostic open-source software for the delivery, curation, and management of services for the modern home. That is, this provides standardization of the communication between devices and the cloud service 40. OpenSync acts as silicon, Customer Premises Equipment (CPE), and cloud-agnostic connection between the in-home hardware devices and the cloud service 40. This is used to collect measurements and statistics from the connected Wi-Fi client devices 16 and network management elements, and to enable customized connectivity services.

As described herein, cloud-based management includes reporting of Wi-Fi related performance metrics to the cloud service 40 as well as receiving Wi-Fi-related configuration parameters from the cloud service 40. The systems and methods contemplate use with any Wi-Fi network 10. The cloud service 40 utilizes cloud computing systems and methods to abstract away physical servers, storage, networking, etc. and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.”

### § 1.2 Distributed Wi-Fi Network

FIG. 2B is a network diagram of an example implementation the Wi-Fi network 10D, as a distributed Wi-Fi network in a tree topology. The distributed Wi-Fi network 10D includes a plurality of access points 22 (labeled as access points 22A—22H) which can be distributed throughout a location, such as a residence, office, or the like. That is, the distributed Wi-Fi 10D contemplates operation in any physical location where it is inefficient or impractical to service with a single access point, repeaters, or a mesh system. In a typical deployment, the distributed Wi-Fi network 10D can include between 1 to 12 access points or more in a home. A large number of access points 22 (which can also be referred to as nodes in the distributed Wi-Fi system 10) ensures that the distance between any access point 22 is always small, as is the distance to any Wi-Fi client device 16 needing Wi-Fi service. That is, an objective of the distributed Wi-Fi network 10D is for distances between the access points 22 to be of similar size as distances between the Wi-Fi client devices 16 and the associated access point 22. Such small distances ensure that every corner of a consumer's home is well covered by Wi-Fi signals. It also ensures that any given hop in the distributed Wi-Fi network 10D is short and goes through few walls. This results in very strong signal strengths for each hop in the distributed Wi-Fi network 10D, allowing the use of high data rates, and providing robust operation.

For external network connectivity, one or more of the access points 14 can be connected to a modem/router 30 which can be a cable modem, Digital Subscriber Loop (DSL) modem, or any device providing external network connectivity to the physical location associated with the distributed Wi-Fi network 10D.

While providing excellent coverage, a large number of access points 22 (nodes) presents a coordination problem. Getting all the access points 22 configured correctly and communicating efficiently requires centralized control. This control is preferably done via the cloud service 40 that can be reached across the Internet 12 and accessed remotely such as through an application (“app”) running on a client device 16. That is, in an exemplary aspect, the distributed Wi-Fi network 10D includes cloud-based control (with a cloud-based controller or cloud service) to optimize, configure, and monitor the operation of the access points 22 and the Wi-Fi client devices 16. This cloud-based control is contrasted with a conventional operation which relies on a local configuration such as by logging in locally to an access point. In the distributed Wi-Fi network 10D, the control and optimization does not require local login to the access point 22, but rather the Wi-Fi client device 16 communicating with the cloud service 4, such as via a disparate network (a different network than the distributed Wi-Fi network 10D) (e.g., LTE, another Wi-Fi network, etc.).

The access points 22 can include both wireless links and wired links for connectivity. In the example of FIG. 2B, the access point 22A has an exemplary gigabit Ethernet (GbE) wired connection to the modem/router 30. Optionally, the access point 22B also has a wired connection to the modem/router 30, such as for redundancy or load balancing. Also, the access points 22A, 22B can have a wireless connection to the modem/router 30. Additionally, the access points 22A, 22B can have a wireless gateway such as to a cellular provider as is described in detail herein. The access points 22 can have wireless links for client connectivity (referred to as a client link) and for backhaul (referred to as a backhaul link). The distributed Wi-Fi network 10D differs from a conventional Wi-Fi mesh network in that the client links and the backhaul links do not necessarily share the same Wi-Fi channel, thereby reducing interference. That is, the access points 22 can support at least two Wi-Fi wireless channels—which can be used flexibly to serve either the client link or the backhaul link and may have at least one wired port for connectivity to the modem/router 30, or for connection to other devices. In the distributed Wi-Fi network 10D, only a small subset of the access points 22 require direct connectivity to the modem/router 30 with the non-connected access points 22 communicating with the modem/router 30 through the backhaul links back to the connected access points 22A, 22B. Of course, the backhaul links may also be wired Ethernet connections, such as in a location have a wired infrastructure.

### § 2.0 ACCESS POINT

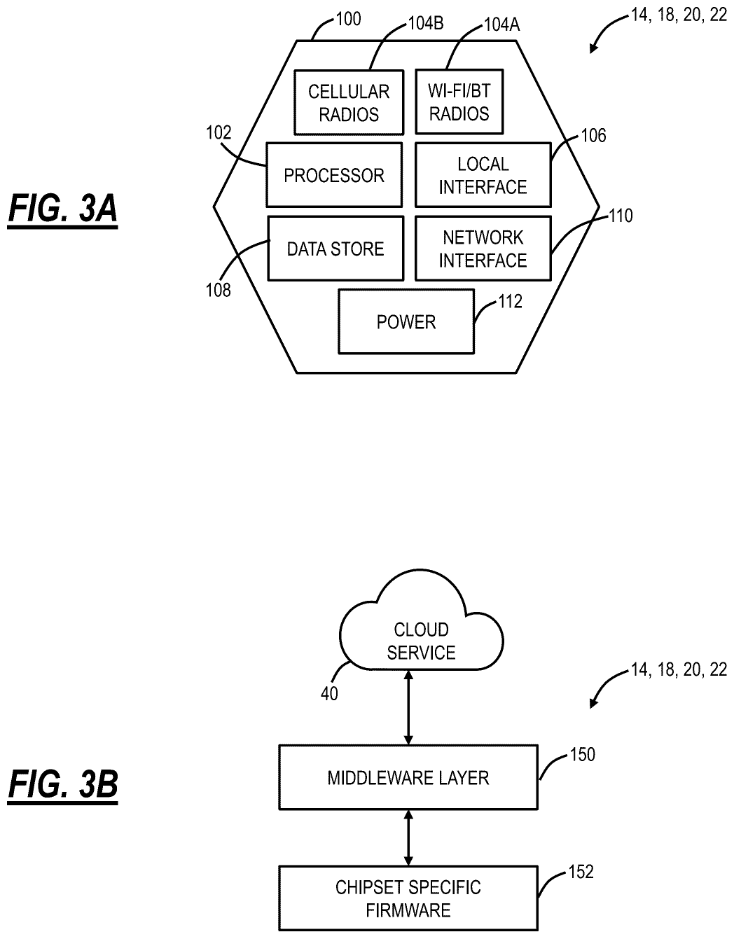

FIG. 3A is a block diagram of functional components of the access points 14, mesh nodes 18, repeaters 20, etc. (“node”) in the Wi-Fi networks 10. The node includes a physical form factor 100 which contains a processor 102, a plurality of radios 104A, 104B, a local interface 106, a data store 108, a network interface 110, and power 112. It should be appreciated by those of ordinary skill in the art that FIG. 3A depicts the node in an oversimplified manner, and a practical embodiment may include additional components and suitably configured processing logic to support features described herein or known or conventional operating features that are not described in detail herein.

In an embodiment, the form factor 100 is a compact physical implementation where the node directly plugs into an electrical socket and is physically supported by the electrical plug connected to the electrical socket. This compact physical implementation is ideal for a large number of nodes distributed throughout a residence. The processor 102 is a hardware device for executing software instructions. The processor 102 can be any custom made or commercially available processor, a central processing unit (CPU), an auxiliary processor among several processors, a semiconductor-based microprocessor (in the form of a microchip or chipset), or generally any device for executing software instructions. When the node is in operation, the processor 102 is configured to execute software stored within memory or the data store 108, to communicate data to and from the memory or the data store 108, and to generally control operations of the access point 14 pursuant to the software instructions. In an embodiment, the processor 102 may include a mobile optimized processor such as optimized for power consumption and mobile applications.

The radios 104A enable wireless communication in the Wi-Fi network 10. The radios 104B can operate according to the IEEE 802.11 standard. The radios 104B support cellular connectivity such as Long-Term Evolution (LTE), 5G, and the like. The radios 104A, 104B include address, control, and/or data connections to enable appropriate communications on the Wi-Fi network 10 and a cellular network, respectively. As described herein, the node can include a plurality of radios 104A to support different links, i.e., backhaul links and client links. The radios 104A can also include Wi-Fi chipsets configured to perform IEEE 802.11 operations. In an embodiment, an optimization can determine the configuration of the radios 104B such as bandwidth, channels, topology, etc. In an embodiment, the node supports dual-band operation simultaneously operating 2.4 GHz and 5 GHz 2×2 MIMO 802.11b/g/n/ac radios having operating bandwidths of 20/40 MHz for 2.4 GHz and 20/40/80 MHz for 5 GHz. For example, the node can support IEEE 802.11AC1200 gigabit Wi-Fi (300+867 Mbps). Also, the node can support additional frequency bands such as 6 GHz, as well as cellular connections. The radios 104B can include cellular chipsets and the like to support fixed wireless access.

Also, the radios 104A, 104B include antennas designed to fit in the form factor 100. An example is described in commonly-assigned U.S. patent Ser. No. 17/857,377, entitled “Highly isolated and barely separated antennas integrated with noise free RF-transparent Printed Circuit Board (PCB) for enhanced radiated sensitivity,” filed Jul. 5, 2022, the contents of which are incorporated by reference in their entirety.

The local interface 106 is configured for local communication to the node and can be either a wired connection or wireless connection such as Bluetooth or the like. Since the node can be configured via the cloud service 40, an onboarding process is required to first establish connectivity for a newly turned on node. In an embodiment, the node can also include the local interface 106 allowing connectivity to a Wi-Fi client device 16 for onboarding to the Wi-Fi network 10 such as through an app on the user device 16. The data store 108 is used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media.

The network interface 110 provides wired connectivity to the node. The network interface 110 may be used to enable the node communicates to the modem/router 30. Also, the network interface 110 can be used to provide local connectivity to a Wi-Fi client device 16 or another access point 22. For example, wiring in a device to a node can provide network access to a device that does not support Wi-Fi. In an embodiment, all of the nodes in the Wi-Fi network 10D include the network interface 110. In another embodiment, select nodes, which connect to the modem/router 30 or require local wired connections have the network interface 110. The network interface 110 may include, for example, an Ethernet card or adapter (e.g., 10BaseT, Fast Ethernet, Gigabit Ethernet, 10 GbE). The network interface 110 may include address, control, and/or data connections to enable appropriate communications on the network.

The processor 102 and the data store 108 can include software and/or firmware which essentially controls the operation of the node, data gathering and measurement control, data management, memory management, and communication and control interfaces with the cloud service 40. The processor 102 and the data store 108 may be configured to implement the various processes, algorithms, methods, techniques, etc. described herein.

Also, those skilled in the art will appreciate there can be various physical implementations which are contemplated herein. For example, in some embodiments, the modem/router 30 can be integrated with the access point 14, 18, 22. In other embodiments, just a router can be integrated with the access point 14, 18, 22 with separate connectivity to a modem.

### § 2.1 OpenSync

FIG. 3B is a logical diagram of the access points 14, mesh nodes 18, repeaters 20, etc. (“node”) with a middleware layer 150 to enable operation with the cloud service 40. Of note, the present disclosure contemplates use with any vendor's hardware for the access points 14, mesh nodes 18, repeaters 20, etc. with the addition of the middleware layer 150 that is configured to operate with chipset specific firmware 152 in the node. In an embodiment, the middleware layer 150 is OpenSync, such as describe in www.opensync.io/documentation, the contents of which are incorporated by reference. Again, OpenSync is cloud-agnostic open-source software for the delivery, curation, and management of services for the modern home. That is, this provides standardization of the communication between devices and the cloud service 40. OpenSync acts as silicon, Customer Premises Equipment (CPE), and cloud-agnostic connection between the in-home hardware devices and the cloud service 40.

The middleware layer 150 spans across layers from just above the firmware drivers to the cloud connection for the cloud service 40. The middleware layer 150 is software operates with the following device segments:

### Measurements/Statistics/Telemetry

Collecting measurements reported by the low-level drivers
Compiling and pre-processing the measurements into statistics that are uniform across different devices
Presenting the statistics using standardized formats
Preparing the formatted statistics for transfer to the cloud using serialization and packetizing
Communicating the statistics to the cloud using standardized and efficient telemetry

### Management/Control

Defining a standard interface for control messaging from the cloud service 40
Providing operations necessary to manage the services, such as onboarding and provisioning
Providing rules-based networking configurations to block, filter, forward, and prioritize the messages
Implementing software to manage the device maintenance functions, including logging, firmware upgrades, and debugging

### Cloud-Managed Services

Wi-Fi, including mesh networks that dynamically adapt to their environments
User access management
Cybersecurity
Parental controls
IoT device management
Additional services

Through use of the middleware layer 150, it is possible to have various different vendor devices operate with the cloud service 40.

### § 2.2 Virtual Network Functions (VNF) on the Access Points

In addition to the middleware layer 150, the present disclosure contemplates the ability for the cloud service 40 to add applications, features, etc. on the nodes. In the present disclosure, the node is configured to maintain tunnels to the corporate network as well as support forwarding based on virtual networks.

### § 2.3 SDN and OpenFlow

In an embodiment, the cloud service 40 can use software defined network (SDN) such as via OpenFlow to control the Wi-Fi networks 10 and the corresponding access points. OpenFlow is described at opennetworking.org and is a communications protocol that gives access to the forwarding plane of a network switch or router over the network. In this case, the forwarding plane is with the access points and the network is the Wi-Fi network 10. The access points and the cloud service can include with OpenFlow interfaces and Open vSwitch Database Management Protocol (OVSDB) interfaces. The cloud service 40 can use a transaction oriented reliable communication protocol such as Open vSwitch Database Management Protocol (OVSDB) to interact with the Wi-Fi networks 10.

The present disclosure includes multiple virtual networks in the Wi-Fi network 10 and one implementation can include SDN such as via OpenFlow.

### § 3.0 CLOUD SERVER AND USER DEVICE

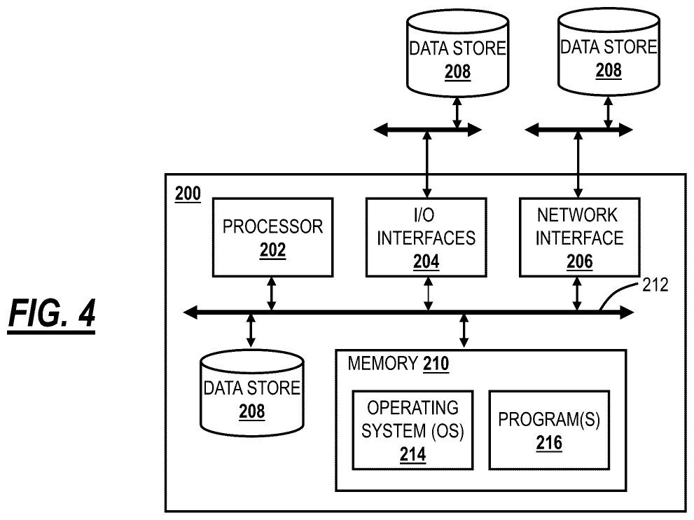

FIG. 4 is a block diagram of functional components of a server 200, a Wi-Fi client device 16, or a user device that may be used with the Wi-Fi network of FIG. 1 or 2B, and/or the cloud-based control of FIG. 2A. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support features described herein or known or conventional operating features that are not described in detail herein.

The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. The user input may be provided via, for example, a keyboard, touchpad, and/or a mouse. System output may be provided via a display device and a printer (not shown). I/O interfaces 204 may include, for example, a serial port, a parallel port, a small computer system interface (SCSI), a serial ATA (SATA), a fibre channel, InfiniBand, ISCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the cloud service 40. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein, such as related to the optimization.

### § 3.1 App for Control

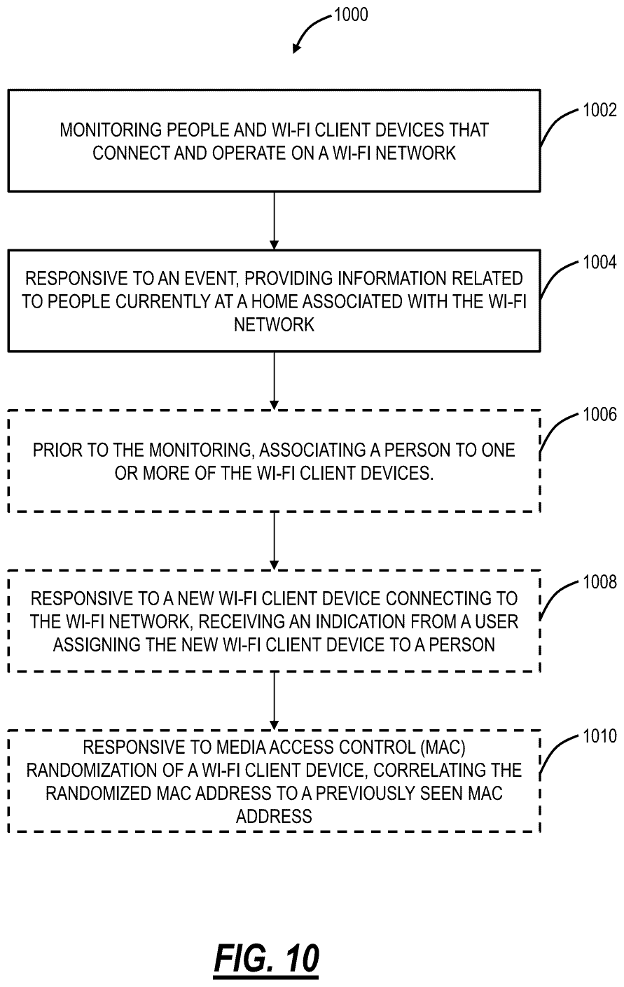

In general, a single app, such as a mobile app, desktop app, etc., can be used to monitor and control the Wi-Fi network 10. The configuration can define security, encryption, SSID, WPA settings, device certificates, prioritization, time of day, etc. In an embodiment, the mobile app is HomePass, available from the Applicant, Plume Design, Inc., and FIG. 10 is an example screenshot of a mobile app. Example features of the mobile app include, without limitation:
Wi-Fi hardware is discovered over Bluetooth so the system is up and running in minutes
Intuitive self-install feature, which eliminates the need for technician costs and scheduling
Advanced, automatic identification of devices in the home, complete with icons and names.
View how the network is connecting with a visual topology representation of all access points and connected devices
Creates flawless connectivity across device types, rooms, and complex environments using AI-based optimization
Provides complex network visibility with unique device fingerprinting and speed tests
The cloud-coordinated system harmonizes legacy deployments via OpenSync-compatible hardware
Privacy Manager to temporarily freeze visibility
Parental control tools to set healthy boundaries for access and usage
Guest Manager for access permissions and passwords
Content Manager to filter and block unwanted websites and ads for parents and more
Digital Wellbeing monitors screen time with scheduled freezes and pauses
Online protection from malicious content—Learn more about protecting homes in the connected age
Real-time threat database
IoT anomaly detection and device quarantine
Intrusion detection and outside threat blocking
Motion detection via radio waves to let subscriber-owned devices become sensors to detect expected and unexpected movement
No need to remember to enable the system, the system turns on and off automatically through GPS of primary devices
See movement patterns over the course of time within the mobile app

### § 4.0 WI-FI NETWORK WITH WIRED AND WIRELESS CONNECTIVITY

Again, the wireless access points 14, 18, 22 include both the Wi-Fi radios 104A, the cellular radios 104B, and the network interface 110. The network interface 110 can include an Ethernet connection to the modem/router 30. In an embodiment, the cellular radios 104B can provide a backup connection to the Ethernet connection, for connectivity to the Internet. Of note, the access point 14, 18, 22 with the cellular radios 104B can be referred to as a gateway 30A node. That is, the term gateway 30A is meant to cover any access point 14, 18, 22, modem/router, etc. or combination thereof that enables connectivity to the Internet 12 for the Wi-Fi network 10. Note, in some embodiments, a modem is separate from the access point 14, 18, 22. In other embodiments, the access point 14, 18, 22, include a router. In still other embodiments, the access point 14, 18, 22 can include a modem/router. Those skilled in the art will recognize various approaches are contemplated and all such equivalents are considered herewith.

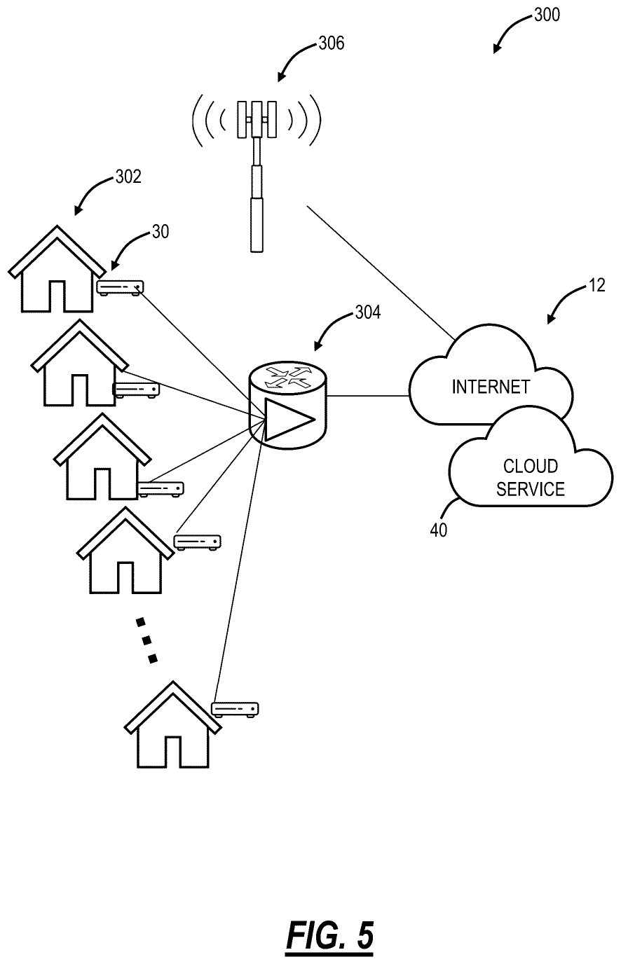

FIG. 5 is a network diagram of a portion of a network 300 associated with a network operator. In this example, the network operator includes both wired and wireless broadband in the same geographical area, represented by homes 302. For example, the wired broadband can be via modems/routers 30 that can connect ultimately to a cable modem termination system (CMTS) 304 (or some other type of wired infrastructure, e.g., DSL, Passive Optical Network (PON), Hybrid Fiber Coax (HFC), etc.), and the wireless broadband can be via fixed wireless access via the cellular radios 104B in the access points 14, 18, 22 that connect to a base station 306 (e.g., eNodeB, gNodeB, etc.). It would be advantageous to support failover to the wireless broadband in the case of a wired broadband failure, providing reliability, uptime, and high service level agreement (SLA) support. In the case of a single outage, this is not an issue on the wireless network. However, often wired failures are geographically localized. For example, failure of the CMTS 304 causes a burden on the base station 306 because the wired broadband failure is geographically localized to the homes 302. This could dramatically put a burden on the base station 306 or other cellular cells in the area, leading to degradation of services for all mobile users in the area. That is, wired broadband outages tend to be localized and using wireless broadband for failover could inundate the cellular network.

### § 4.1 Fixed Wireless Access System

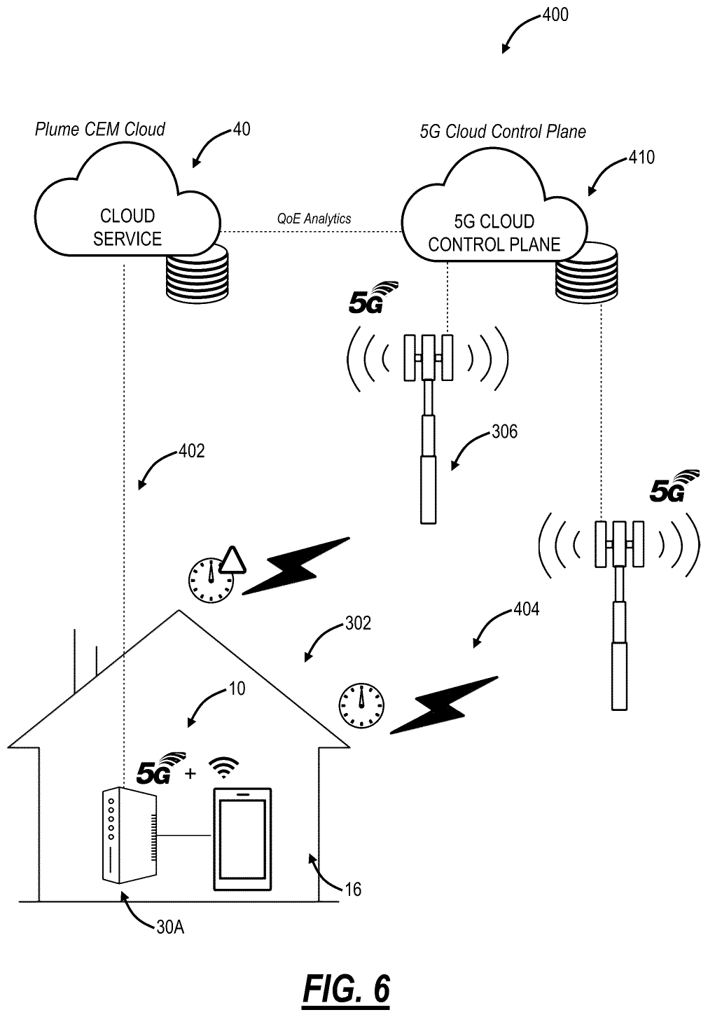

FIG. 6 is a diagram of a fixed wireless access system 400 for wired and/or wireless connectivity. For illustration purposes, the fixed wireless access system 400 is illustrated with a single home 302 having a modem/router 30 and a Wi-Fi client device 16. Those skilled in the art will recognize the fixed wireless access system 400 contemplates multiple locations, including homes, businesses, store, library, mall, sporting area, or any location where a Wi-Fi network 10 is deployed. Further, the fixed wireless access system 400 contemplates use with various different Wi-Fi networks 10, with various different network operators, etc. Also, the fixed wireless access system 400 contemplates use with any of the various wired and/or wireless connectivity schemes described herein.

The cloud service 40 is configured to connect to the Wi-Fi network 10, either via a wired connection 402 and/or a wireless connection 404. In an embodiment, the cloud service 40 can be utilized for configuration, monitoring, and reporting of the Wi-Fi networks 10 in the homes 302 or other locations. The cloud service 40 can be configured to detect outages such as for the wired connections 402. For example, this functionality is described in commonly-assigned U.S. patent application Ser. No. 17/700,782, filed Mar. 22, 2022, and entitled “Intelligent monitoring systems and methods for Wi-Fi Metric-Based ISP Outage Detection for Cloud Based Wi-Fi Networks,” the contents of which are incorporated by reference in their entirety.

Also, the cloud service 40 can connect to a 5G cloud control plane 410 and can determine 5G to Wi-Fi quality of experience (QoE) monitoring and application prioritization controls for increased service consistency. QoE analytics can be shared with 5G cloud control plane 410 for network optimization feedback.

In an embodiment, the access points 14, 18, 20, 22 and/or gateway 30A can include OpenSync support for communicating with the cloud service 40.

### § 5.0 MONITORING FEATURES FOR HOME SECURITY, ELDER CARE, SAFETY, WELLNESS, ETC.

Again, the present disclosure leverages several functions performed in or with the Wi-Fi network 10 and the cloud service 40. The functions include:
(1) Detection of who is or is not home, based on specific Wi-Fi client devices 16;
(2) Media Access Control (MAC) stitching which counteracts MAC randomization;
(3) Locating function in the Wi-Fi network, such as via radar antennas, Ultrawide Bandwidth (UWB) antennas, as well as via disturbances in Wi-Fi signals based on motion; and
(4) Fall detection such as via a smart ring.

These functions can be used, individually or in combination, to detect users when there is a need, e.g., safety emergencies and the like. The emergencies can include, without limitation,
A fire is reported to be raging in a specific home;
A home security system issued a distress signal, but there is no voice communication with the initiator;
A neighbor reported screaming or violence in the home;
A hurricane or an earthquake makes reaching a specific home impossible, but it's important to know who might be present there;
Fall detection;
Elder care;
And the like.

### § 5.1 User Detection in a Home

First, the present disclosure includes a user detection feature (“people at home”) with respect to the Wi-Fi network 10 and the cloud service 40. In an embodiment, this is based on assigning one or more Wi-Fi client devices 16 to a user and detecting a presence of the assigned Wi-Fi client devices 16 on the Wi-Fi network 10. For example, the one or more Wi-Fi client devices 16 can be devices that are always likely to be with the user, such as a smart phone, smart watch, fitness tracker, smart ring, etc. The assumption is that when that Wi-Fi client device 16 is on the Wi-Fi network 10, the user is local, i.e., in the house. This is based on the fact that these Wi-Fi client devices 16 are always worn or with the user.

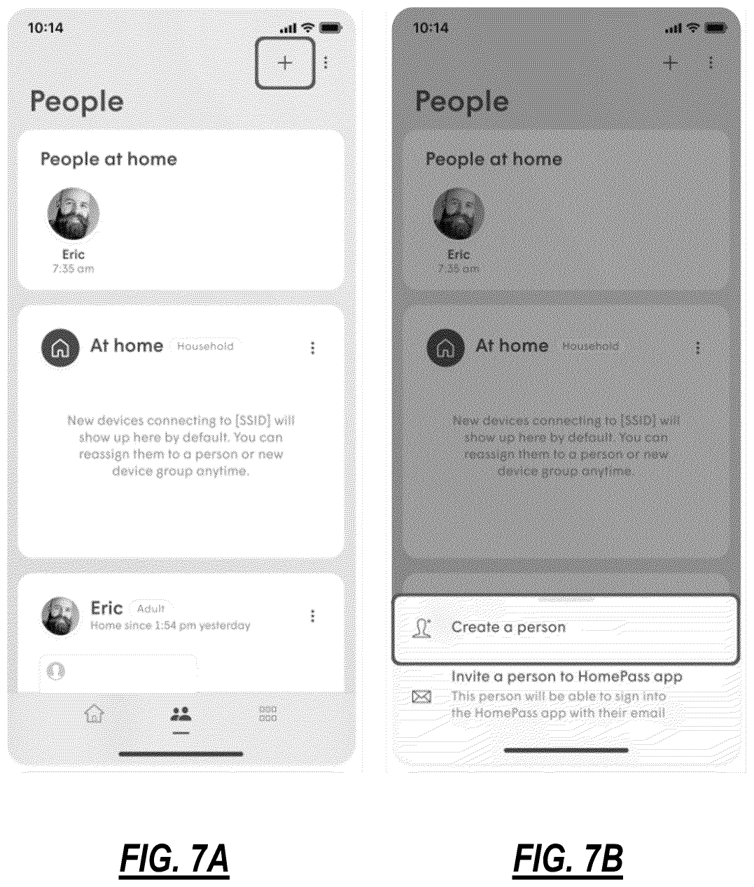

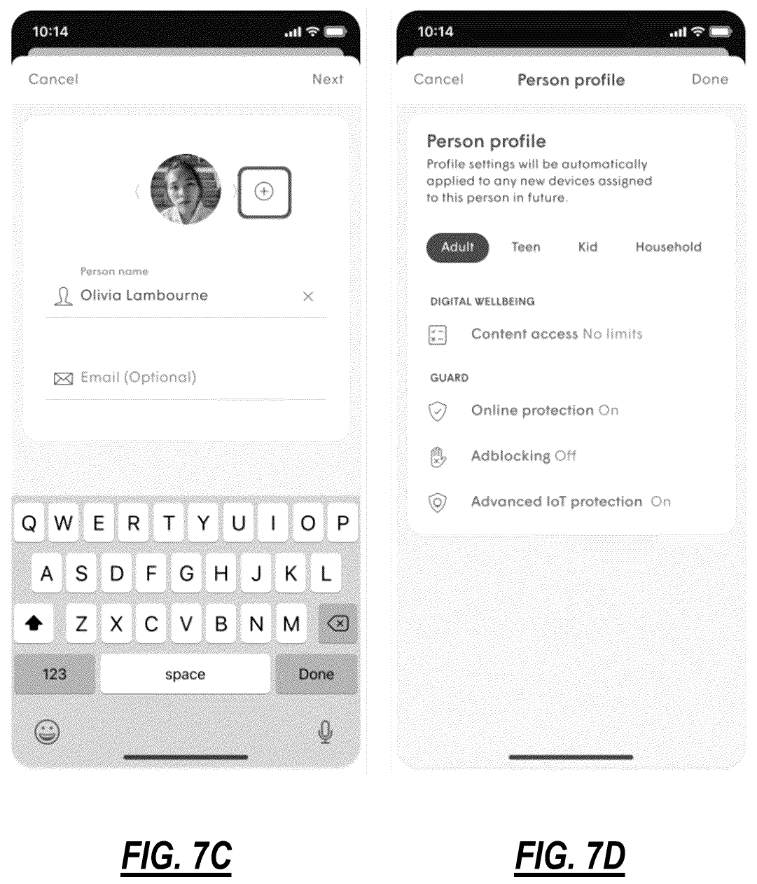

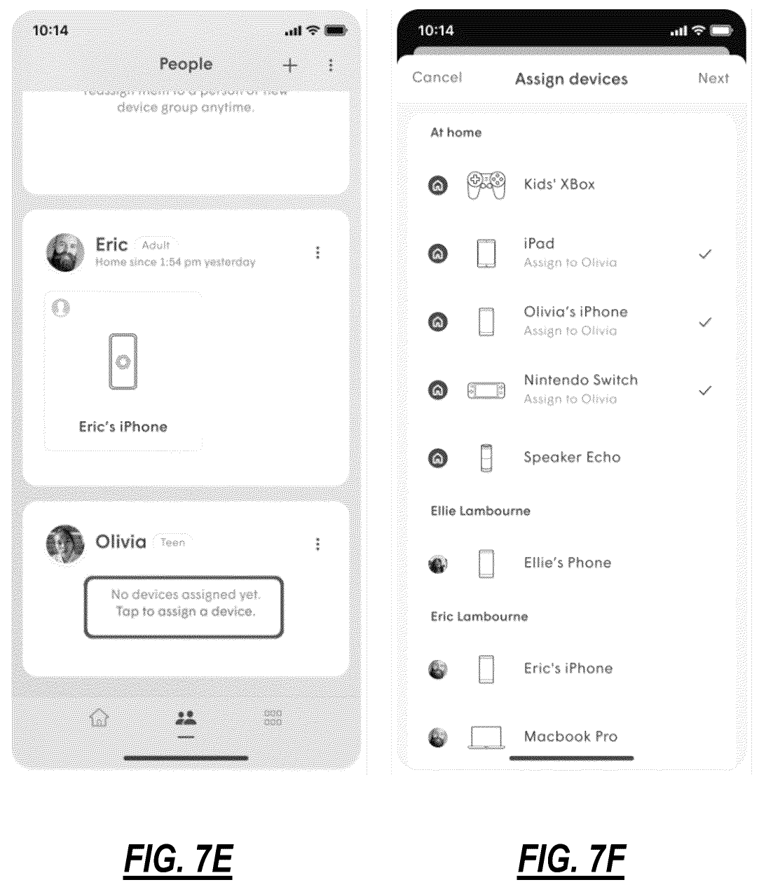

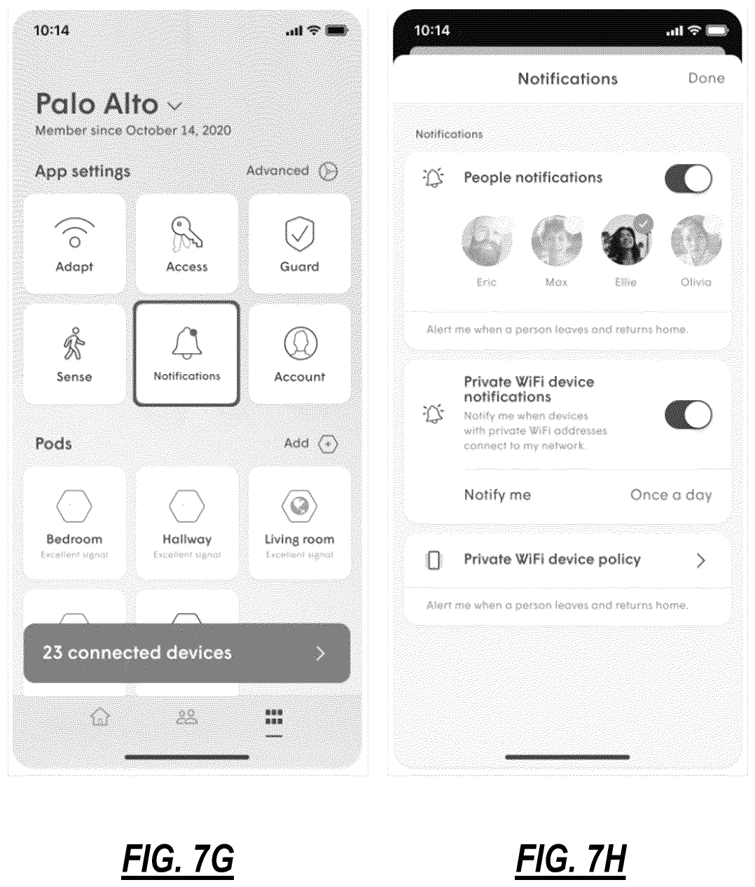

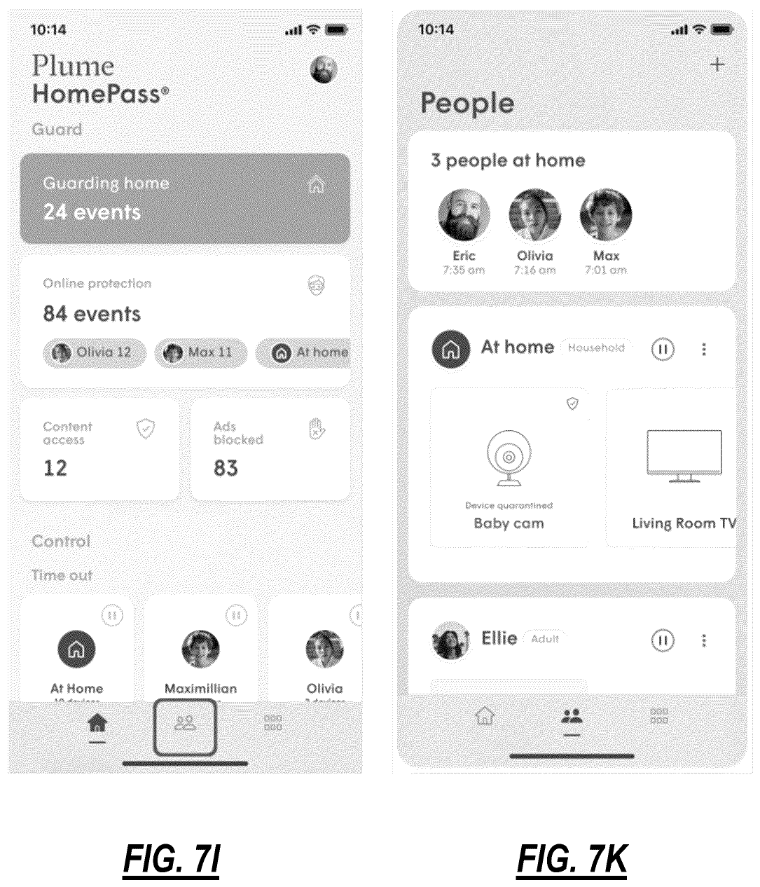

The user detection feature can be implemented via the app and the cloud service 40. FIGS. 7A-7K are screenshots of a mobile app illustrating the user detection feature. The user detection feature includes:

(1) Creating a person profile from a person screen in the app. FIG. 7A illustrates the person screen which includes a notification of people at home and there is a “+” sign to add a new person. FIG. 7B illustrates an option to create a person based on selecting the “+” sign. FIG. 7C includes a name for the person, an optional email, and an optional photo. FIG. 7D includes a profile for the person, including predefined profiles for adults, teens, kids, etc., as well as options for the user on the Wi-Fi network.

(2) Assigning one or more Wi-Fi client devices 16 to the person. FIG. 7E illustrates assigning a device to a person. FIG. 7F illustrates Wi-Fi client devices 16 that have been seen on the Wi-Fi network 10. A user can assign to the person by selecting from the list.

(3) Enabling people notifications. FIG. 7G illustrates a notifications screen. FIG. 7H illustrates enabling people notifications.

(4) The Wi-Fi network 10 and/or the cloud service 40 monitors and updates the app with the people at home. FIG. 7I illustrates a people tab in the app. FIG. 7K illustrates a display of the people at home based on selecting the people tab.

In addition to displaying the people at home in the app, the cloud service 40 can provide such information to third parties, namely fire, police, medical, 911 systems, home security monitoring services, and the like.

The user detection feature can be in any Wi-Fi network 10, including the Wi-Fi network 10A with a single access point, as well as any Wi-Fi network utilizing OpenSync or some other middleware layer. Further, in the Wi-Fi networks 10B—10D, it is possible to further segment the user detection feature to determine a location in the home based on which access point is serving the assigned Wi-Fi client devices 16, i.e., the assumption being the person would be local with the assigned Wi-Fi client devices 16.

In an embodiment, automobiles are not connecting to the Wi-Fi network and this can be used to determine whether anyone is home or not, i.e., not necessarily a count of people by a TRUE/FALSE as to whether anyone is home.

### § 5.2 MAC Stitching to Counteract MAC Randomization

Of note, the Wi-Fi network 10 can detect the devices based on their MAC address. As such, many devices are employing so-called MAC randomization features that seek to prevent tracking of user devices based on their MAC address. This is specifically being implemented in Apple devices (iOS), Android devices, and Microsoft devices. Unfortunately, MAC randomization prevents device tracking. However, MAC randomization is really about third-party Wi-Fi networks 10 tracking and not necessarily meant for home networks with the user's own devices.

Certain features and policies rely on a consistent MAC address on the device to function, such as:
People assignments;
People At Home
Content Access rules;
Device freeze schedules;
Device and Person level Guard rules; and
IP reservations and port forwarding.

Every time a device changes its MAC address, the device can appear as new to the Wi-Fi network 10 and these rules/configurations will have to be applied to the device again. Depending on the implementation being used on the device, the MAC can change whenever there is an SSID change, the Wi-Fi network is forgotten or even Daily (e.g., Windows 10). Of note, smart phones, smart watches, smart rings, etc. all typically implement MAC randomization.

The present disclosure contemplates various approaches to counteract MAC randomization. First, the user can disable the MAC randomization on IOS, Android, or Windows. Second, the Wi-Fi network 10 and/or the cloud service 40 can notify the user via the app every time a new device accesses the Wi-Fi network 10. The user can then assign the device to a person. For example, assuming Apple iPhones now have a new randomized MAC address, the user can see an instant push notification and then deduce the iPhone just came back on the Wi-Fi network 10.

Third, the Wi-Fi network 10 and/or the cloud service 40 can implement so-called MAC stitching which means that a new MAC address shows up on the Wi-Fi network 10 and it can be automatically assigned to an existing MAC address with the assumption they are the same device, with a different MAC address due to randomization. That is stitching is performed via connecting (“stitching”) two different MAC addresses together.

Various approaches to MAC stitching are described in commonly-assigned U.S. patent application Ser. Nos. 17/731,397 and 17/521,949, filed Apr. 28, 2022, and Nov. 9, 2021, respectively, and entitled “Identifying Wi-Fi devices based on user behavior,” and “Counteracting MAC address randomization and spoofing attempts,” respectively, the contents of which are incorporated by reference in their entirety.

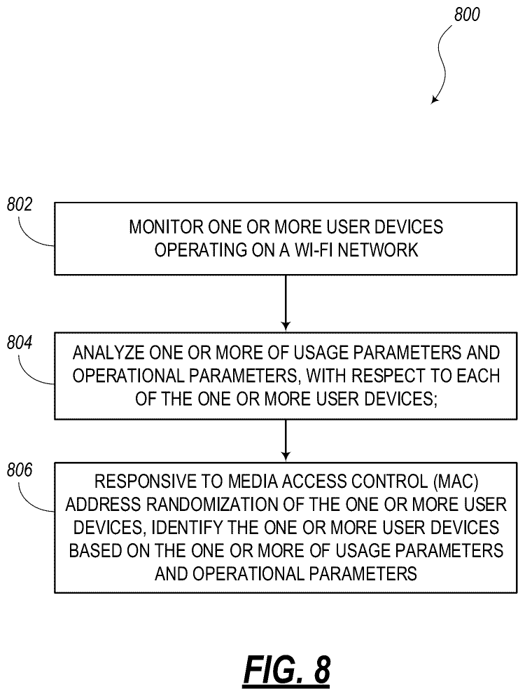

FIG. 8 is a flow diagram illustrating an embodiment of a process 800 for identifying a user device to counteract MAC randomization. Based on identifying a device, the systems and methods may further be configured to stitch MAC addresses together based on this usage behavior. As illustrated, the process 800 includes the step of monitoring one or more user devices operating on a Wi-Fi network, as indicated in block 802. The process 800 further include the step of analyzing one or more of usage parameters and operational parameters, with respect to each of the one or more user devices, as indicated in block 804. Also, the process 800 includes, responsive to Media Access Control (MAC) address randomization of the one or more user devices, identifying the one or more user devices based on the one or more of usage parameters and operational parameters, as indicated in block 806.

In some embodiments, the process 800 may further include the steps of a) retrieving a device identifier associated with each of the one or more user devices, and b) correlating the device identifier of each of the one or more user devices with an operational identity based on the usage parameters. For example, the device identifier associated with each of the one or more user devices may be a Media Access Control (MAC) address. The process 800 may also include the steps of a) detecting when a new MAC address is retrieved with respect to an unidentified user device operating on the Wi-Fi network, b) analyzing current usage parameters of the unidentified user device, and c) comparing the current usage parameters of the unidentified user device with the usage parameters of the one or more previously-identified user devices. In response to determining that the current usage parameters match the usage parameters of one of the previously-identified user devices, the process 800 may perform the step of stitching the new MAC address with the MAC address of the corresponding previously-identified user device. Alternatively, in response to determining that the current usage parameters do not match the usage parameters of the one or more previously-identified user devices, the process 800 may perform the step of tagging the unidentified user device as a new device to be monitored on the Wi-Fi network.

The process 800 may also include the step of analyzing, over a period of time, the usage parameters with respect to each of the one or more user devices. Then, based on the usage parameters analyzed over time, the process 80 may include creating one or more behavioral models associated with one or more users, whereby each behavioral model may represent a usage pattern of a respective user according to how the user uses at least one of the devices. In some embodiments, the step of analyzing the usage parameters over time may include utilizing a machine learning technique to create the one or more behavioral models. The process 800 may further include the steps of a) assigning one or more unique user identifiers for representing the one or more users, and b) associating the one or more unique user identifiers with the one or more behavioral models. Also, the process 800 may include the step of retraining the one or more behavioral models based on changes to the usage parameters of each corresponding user.

According to additional embodiments, the usage parameters described herein may be related to an identity of one or more apps installed on the one or more user devices. Also, the usage parameters may be related to app usage information, where the app usage information may include a) a frequency of use of one or more apps, b) a time spent in each of the one or more apps, c) a type of communication associated with app use, d) a time of day of app use, and/or other information. Furthermore, the usage parameters may be related to an identity of one or more websites or domains accessed by the one or more user devices.

In some embodiments, the process 800 may include the step of refining an identity of each of the one or more user devices based on weighted values of multiple metrics. The metrics may include a) an identity of one or more apps installed, b) app usage information, c) browsing patterns, and/or other metrics. The weighted values, for example, may be related to a uniqueness of each of the metrics. The user devices mentioned herein may include smart phones, computers, laptops, tablets, smart televisions, Internet of Things (IoT) devices, media players, or other suitable devices in communication with the Wi-Fi network. In some implementations, the usage parameters may be related to device-based behaviors, such as a) Wi-Fi access point usage, b) Wi-Fi network connection patterns, c) Bluetooth-related transmission, d) device port usage, and/or other behaviors associated with the devices.

### § 5.3 Locating Function in the Wi-Fi Network

In a further embodiment, there can be a locating function in the Wi-Fi network 10, to provide further granularity regarding users at home. The objective of the locating function is to be able to pinpoint approximate locations of people in the home. This can include simply there are X people in the living room, as well as showing user A is in the living room. The present disclosure contemplates various approaches, including, for example, radar antennas embedded in the access points, UWB antennas in the access points, determining what devices connect to what access points in multiple access point systems, and detecting disturbances in Wi-Fi signals based on motion.

Of note, determining what devices connect to what access points in multiple access point systems, this approach can pinpoint specific people to a location. The other approaches can just provide some visibility to location, but not specific persons.

### § 5.3.1 Radar

The use of radar is described in commonly-assigned U.S. patent Ser. No. 17/693,805, filed Mar. 14, 2022, and entitled “Radar-based movement sensors arranged in a domestic setting,” the contents of which are incorporated by reference in their entirety. This radar approach includes one or more radar-based sensors incorporated in the housing of the respective access point, as well as separate but in communication with the Wi-Fi network 10. Further, the radar approach can include analysis of radar data to identify a human activity and to determine one or more characteristics of the human activity.

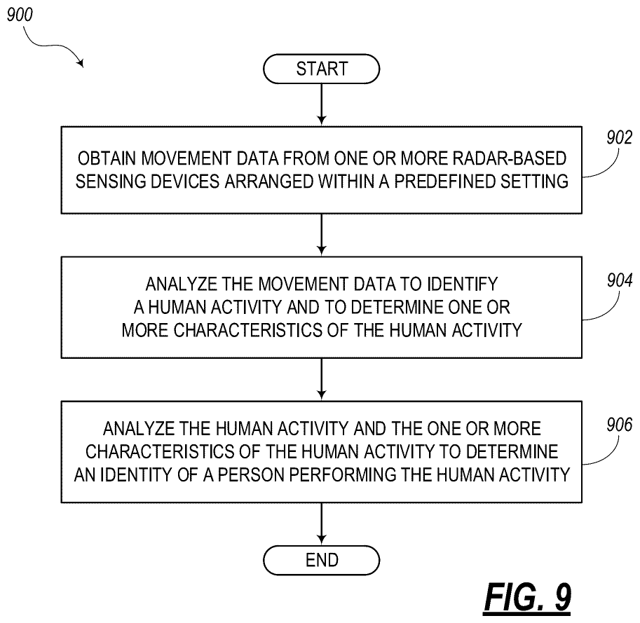

FIG. 9 is a flow diagram illustrating an embodiment of a process 900 for utilizing information obtained from radar-based sensors to detect human movement within a domestic setting. In the illustrated embodiment, the process 900 includes a step of obtaining movement data from one or more radar-based sensing devices arranged within a predefined setting (step 902). The process 900 also include a step of analyzing the movement data to identify a human activity and to determine one or more characteristics of the human activity (step 904). Also, the process 900 includes analyzing the human activity and the one or more characteristics of the human activity to determine an identity of a person performing the human activity (step 906).

According to some embodiments, the process 900 may be executed by the hub device, access point, sensor, or other suitable device having access to the information obtained by one or more various radar detecting sensors in a monitoring system. In some embodiments, each of the one or more radar-based sensing devices may be housed in an access point of a local Wi-Fi network 10.

The movement data described above may include micro-Doppler data based on reflection signals received by the one or more radar-based sensing devices with respect to time. The one or more radar-based sensing devices may be configured to utilize one or more of Intermediate Frequency (IF) signals, Frequency Modulation (FM) signals, Continuous Wave (CW) signals, Frequency Modulation Continuous Wave (FMCW) signals, Ultra-Wideband (UWB) signals, in-phase signals, quadrature signals, pulsed reflection signals, pulsed Doppler signals, micro-Doppler signals, distance-indicating signals, and time-series signals.

The predefined setting described in step 502 may be a domestic environment having a plurality of spaces or rooms. The system may include a plurality of radar-based sensing devices oriented at one or more angles and configured to monitor one or more of the spaces or rooms of the domestic environment. For example, in some embodiments, two radar-based sensing devices may be oriented orthogonal to each other (or at any suitable angle with respect to each other) to enable the detection of movement in any direction.

The human activity may be identified out of a plurality of detectable actions including walking, running, falling, rising from a seated or lying position, lowering into a seated or lying position, exercising, carrying objects, cooking, cleaning, using a home appliance, using a computer or mobile device, opening or closing a door, moving in a wheelchair or scooter, walking with the assistance of a walker or cane, and/or any other suitable actions. The characteristics of the human activity may be identified from a list of detectable parameters including speed, acceleration, direction, location within the predefined setting, gait, balance, steadiness, variability, physical well-being, behavioral well-being, and/or other suitable detectable parameters.

The process 900 may also include the steps of characterizing the human activity in a spectrogram and utilizing the spectrogram to determine the one or more characteristics of the human activity. Determining the identity of the person performing the human activity may include distinguishing the identity of the person from one or more other people in the predefined setting. In some embodiments, identify people may further include identifying pets (e.g., dogs, cats, birds, etc.) living in the domicile and monitor the various characteristics of their movements as well. Distinguishing the identity of a specific person from the one or more other people (and pets) may include clustering the movement data based at least on location information to identify a plurality of people in the predefined setting.

The step of determining the identity of the person performing the human activity (e.g., step 506) may include comparing the one or more characteristics of the human activity with pre-stored behavioral patterns. For example, the pre-stored behavioral patterns may be based on a) supervised training data obtained by monitoring the person and used for training a Machine Learning (ML) model and/or b) generalized data representing normal human behavior obtained by monitoring a test subject in a lab.

According to some embodiments, the process 900 may also include an assessment of the behavior patterns to determine if the person is at risk of falling. For example, medical research has shown that people who tend to pause a long time after standing up before they start walking have more of a fall risk than others. Thus, the process 900 may include determining an amount of time between the action of standing up and the starting of the walking movement. This information can be used to assess fall risk. Also, the systems and methods of the present disclosure may also determine variability of steps, which may also be used to assess fall risk. Other characteristics and/or changes in behavior can be used to indicate a change (or increase) in fall risk.

In some embodiments, the process 900 may further include the step of obtaining audio data from the predefined setting when the movement data is obtained. Then, the process 900 may include combining the audio data with the movement data to enhance the identifying of the human activity and the detection of the one or more characteristics of the human activity. Also, the process 900 may include comparing the one or more characteristics of the human activity with pre-stored normal human behavior or with historic data associated with the identified person. Then, the process 900 may include determining a health or safety risk based on the comparison and automatically notifying a caregiver if the health or safety risk is greater than a predetermined threshold.

In addition, the process 900 may be further defined whereby analyzing the movement data to identify the human activity (e.g., step 502) may include identifying non-human motion data and filtering out the non-human motion data from the movement data. Identifying the non-human motion data may include identifying actions performed by a pet, a robot vacuum device (e.g., Roomba), a door, a drawer, a fan, a home appliance, and/or other spurious or background sound, noise signals, etc. In some embodiments, the process 900 may also include automatically performing any number of responsive actions, as needed. These may be based on the identification of the human activity, the one or more characteristics of the human activity, and/or the identity of the person performing the human activity. The responsive actions, for example, may include a) controlling lights, b) controlling an HVAC system, c) controlling a security system, d) controlling utility appliances, e) controlling kitchen appliances, f) controlling entertainment devices, and/or g) sending an alert or alarm signal to a family member, medical/emergency professional, or other assigned contact person.

The alerts may be further characterized based on certain activities identified. For example, in response to the detection of a fall or a fall risk assessment, an alert may be sent to medical or emergency personnel. In response to a child arriving home, an alert may be sent to a parent. In response to detection of an unidentified person (or a specifically-identified but unwelcome person) entering the home, an alert can be sent to law enforcement personnel or a trusted friend or family member. In response to detection of a seizure event, an evaluated degradation of wellness, a higher than usual fall risk, a significant reduction in walking speed, or other specifically recognizable physical or medical condition, the system may send an alert to a doctor, a doctor's office, emergency personnel, medical personnel, etc.

The responsive actions may be part of or constitute functionality of a smart home system. Therefore, as a result of radar detection as an indication of human activity, certain home automation controls may be executed. Automatic control profiles may be set up to control devices within the smart home. These profiles may be universal (i.e., for any person in the home) or individual (i.e., for each particular person). The individual controls can be programmed into the system to indicate that person's preferences or tastes. One universal control configuration may be a responsive action of turning on the lights in specific rooms when radar sensors show motion in that room. Individual controls may include the responsive actions of playing a particular type of music for a particular person, setting the lights to preferred level, color, etc. for the particular person, setting the temperature (thermostat) of an HVAC system to particular temperature for the particular person, automatically brewing a certain type of coffee for the particular person.

Also, responsive actions may include detecting certain activities and responding accordingly. For example, the systems and methods of the present disclosure (e.g., smart home system) may include, in response to detecting when a person is sleeping, performing the actions of turning off the lights, computer, television, etc., turning on a security system in all rooms except the room where person is sleeping. In response to detecting when a person leaves a home, the system may automatically turn on the security system. In response to detecting when a person wakes up and/or gets out of bed, the system may automatically turn on the lights, turn off the security system, adjust the HVAC settings, etc. In response to detecting a person doing exercises (e.g., running on a treadmill), the system may turn down the heat.

Before monitoring the movement data, the process 900 may further include the step of performing pre-processing actions on the movement data. For example, the pre-processing actions may include a) normalization, b) clipping, c) band pass filtering, d) DC offset removal, e) noise reduction, and/or other pre-processing steps. Also, other pre-processing actions may include grouping samples of the movement data to balance resolution in the time and frequency domains. For example, balancing time and frequency domains may include a process of selecting window size (for the data) that optimizes frequency resolution while maintaining sufficient time resolution to detect motion. This may include a zero padding process to increase frequency resolution while preserving responsiveness to changes in the signal. This may also include centering of the signal within the window.

In some embodiments, the process 900 may also include monitoring an identity and location of a wireless device (e.g., tracker tag) associated with the person to enhance determining the identity of the person performing the human activity. This wireless device may be a mobile phone, a wearable electronic device, a device for monitoring vital statistics (e.g., heart rate, etc.), an Ultra-Wideband (UWB) tracker tag, or other suitable devices.

### § 5.3.2 UWB

Use of a UWB antenna with the Wi-Fi network 10 is described in commonly-assigned U.S. patent application Ser. No. 17/034,291, filed Sep. 28, 2020, and entitled “Antenna with Uniform Radiation for Ultra-Wide Bandwidth,” the contents of which are incorporated by reference in their entirety. Further, this UWB antenna, in an access point or with a Wi-Fi network 10, can be used to detect a location of a tracker tag, such as described in commonly-assigned U.S. patent application Ser. No. 17/511,877, filed Oct. 27, 2021, and entitled “Tracker tag with dual-purpose antenna components,” the contents of which are incorporated by reference in their entirety.

### § 5.3.3 Motion Detection

In an embodiment, it is possible to detect motion based on disturbances in Wi-Fi Radio Frequency (RF) signals observed at an access point. The assumption is that motion relates to a person or pet. This motion detection approach detects the disturbances in Wi-Fi signals between access points or between an access point and a motion detection capable device. These disturbances in the signal are translated into motion events, which you can use to keep yourself aware of activity in your home.

### § 5.4 Fall Detection

Fall detection such as via a smart ring or smart phone is described in commonly-assigned U.S. patent application Ser. No. 17/714,220, filed Apr. 6, 2022, and entitled “Smart ring for use with a user device and Wi-Fi network,” the contents of which are incorporated by reference in their entirety. A smart device, e.g., ring, phone, fitness tracker, etc. can include an accelerometer configured to detect motion and/or falls. The smart device can be connected to the Wi-Fi network 10 and/or the cloud service 40.

### § 6.0 HOME MONITORING PROCESS

FIG. 10 is a flowchart of a home monitoring process 1000, for home security, elder care, safety, wellness, monitoring, and the like via a Wi-Fi network. The home monitoring process 1000 contemplates implementation by the Wi-Fi network 10 as well as optionally with the cloud service 40.

The home monitoring process 1000 includes monitoring people and Wi-Fi client devices that connect and operate on a Wi-Fi network (step 1002); and, responsive to an event, providing information related to people currently at a home associated with the Wi-Fi network (step 1004). The event can be a security emergency. The detection can be via a security system, via a manual request from the app by a user, via the cloud service 40, via an external monitoring system, responsive to a call to emergency services (e.g., 911), and the like.

The home monitoring process 1000 can include, prior to the monitoring, associating a person to one or more of the Wi-Fi client devices (step 1006). The home monitoring process 1000 can include, responsive to a new Wi-Fi client device connecting to the Wi-Fi network, receiving an indication from a user assigning the new Wi-Fi client device to a person (step 1008).

The information related to people can include detection of a specific Wi-Fi client device being on the Wi-Fi network where the specific Wi-Fi client device is previously assigned to a person. The providing information can be to one or more of emergency services, police, a security monitoring service, fire, and designated third persons. For example, designated third persons can be emergency contacts for elder care or the like.

The providing information can be to a security monitoring service that uses the information to determine whether or not to dispatch any of police, fire, and medics. The information can be used in lieu of a camera to verify people are at a location of the Wi-Fi network. For example, some security monitoring services require some confirmation of people at home before dispatching emergency services, such as to avoid false positives which are a waste of emergency resources. A traditional way to verify includes a camera inside the home, which is extremely intrusive. This approach can provide verification without the intrusion. In addition, the granularity can be used to help emergency services go to the right location. The providing information can include privacy controls where an administrator of the Wi-Fi network determines a level of the information from specific named persons to a count of the people. That is, the homeowner can control what is shared—maybe 3 people only in house—control sharing and with who and at what times.

The information can include at least a number of the people and an approximate location of any of the people in a location of the Wi-Fi network. The approximate location can be based on a radar sensing device associated with the Wi-Fi network, disturbances in Wi-Fi signals of the Wi-Fi network, which Wi-Fi client devices are connected to which access point in a multiple access point Wi-Fi network, Ultrawide Bandwidth (UWB) detection, and a combination thereof.

The home monitoring process 1000 can include, responsive to Media Access Control (MAC) randomization of a Wi-Fi client device, correlating the randomized MAC address to a previously seen MAC address (step 1010).

The cloud service 40 collects information about the Wi-Fi devices in the home, Motion events in the home, and can use these sources of information to prepare a report listing the “people likely in the home”, by noting that, for example, Yossi iPhone and Yossi's MacBook are both currently at home, and that Rachel's AppleWatch and Tesla are at home, to indicate that Rachel is likely in the home, to generate such a list, and share it with whoever is subscribed to this service (security provider, or first responders in a given area).

### § 7.0 CONCLUSION

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method comprising steps of:
monitoring people and Wi-Fi client devices that connect and operate on a Wi-Fi network; and
responsive to an event, providing information related to people currently at a home associated with the Wi-Fi network.

2. The method of claim 1, wherein the steps further include:
prior to the monitoring, associating a person to one or more of the Wi-Fi client devices.

3. The method of claim 1, wherein the steps further include:
responsive to a new Wi-Fi client device connecting to the Wi-Fi network, receiving an indication from a user assigning the new Wi-Fi client device to a person.

4. The method of claim 1, wherein the information related to people includes detection of a specific Wi-Fi client device being on the Wi-Fi network where the specific Wi-Fi client device is previously assigned to a person.

5. The method of claim 1, wherein the providing information is to one or more of emergency services, police, a security monitoring service, fire, and designated third persons.

6. The method of claim 1, wherein the providing information is to a security monitoring service that uses the information to determine whether or not to dispatch any of police, fire, and medics.

7. The method of claim 6, wherein the information is used in lieu of a camera to verify people are at a location of the Wi-Fi network.

8. The method of claim 1, wherein the providing information includes privacy controls where an administrator of the Wi-Fi network determines a level of the information from specific named persons to a count of the people.

9. The method of claim 1, wherein the information includes at least a number of the people and an approximate location of any of the people in a location of the Wi-Fi network.

10. The method of claim 9, wherein the approximate location is based on a radar sensing device associated with the Wi-Fi network.

11. The method of claim 9, wherein the approximate location is based on disturbances in Wi-Fi signals of the Wi-Fi network.

12. The method of claim 9, wherein the approximate location is based on which Wi-Fi client devices are connected to which access point in a multiple access point Wi-Fi network.

13. The method of claim 9, wherein the approximate location is based on Ultrawide Bandwidth (UWB) detection.

14. The method of claim 1, wherein the steps further include:
responsive to Media Access Control (MAC) randomization of a Wi-Fi client device, correlating the randomized MAC address to a previously seen MAC address.

15. The method of claim 1, wherein the steps further include:
identifying whether a person is at home where the Wi-Fi network is based on a type of Wi-Fi client device being on the Wi-Fi network.

16. The method of claim 15, wherein the type is one of a wearable device, smart phone, tablet, automobile, and fitness tracker.

17. A cloud service comprising one or more processors and a network interface to a Wi-Fi network, the one or more processors are configured to implement steps of:
monitoring people and Wi-Fi client devices that connect and operate on the Wi-Fi network; and
responsive to an event, providing information related to people currently at a home associated with the Wi-Fi network.

18. The cloud service of claim 17, wherein the steps further include:
prior to the monitoring, associating a person to one or more of the Wi-Fi client devices.

19. A Wi-Fi network comprising:
one or more access points, at least one access point being connected to a cloud service that is configured to:
monitor people and Wi-Fi client devices that connect and operate on the Wi-Fi network; and
responsive to an event, provide information related to people currently at a home associated with the Wi-Fi network.

20. The Wi-Fi network of claim 19, wherein the information related to people includes detection of a specific Wi-Fi client device being on the Wi-Fi network where the specific Wi-Fi client device is previously assigned to a person.
